(19) United States
(12) Patent Application Publication
(10) Pub. No.: US 2019/0325497 A1
(43) Pub. Date: Oct. 24, 2019

(54) SERVER APPARATUS, TERMINAL APPARATUS, AND INFORMATION PROCESSING METHOD

(71) Applicant: SCIGINEER, INC., Tokyo (JP)

(72) Inventor: Shinichiro YOSHII, Tokyo (JP)

(73) Assignee: Scigineer, Inc., Tokyo (JP)

(21) Appl. No.: 16/312,265

(22) PCT Filed: Jun. 19, 2017
(86) PCT No.: PCT/JP2017/022477

§ 371 Date: Dec. 20, 2018

(30) Foreign Application Priority Data
Jun. 24, 2016 (JP) 2016-125099

(51) Int. Cl. G06Q 30/06; G06F 16/54; G06Q 20/12; G06N 20/00; G06K 9/00; H04N 1/00

(52) U.S. Cl. CPC G06Q 30/0623; G06F 16/54; G06Q 30/0635; G06Q 20/12; H04N 2201/0084; G06K 9/00671; H04N 1/00209; H04N 1/00244; G06Q 30/0641; G06N 20/00

(57) ABSTRACT

In order to address a conventional problem that it is not possible to recommend information using a captured photo, a terminal apparatus includes: a terminal transmitting unit that transmits a photo to a server apparatus; a terminal receiving unit that receives recommendation information; and a terminal output unit that outputs the recommendation information, and a server apparatus includes: an image receiving unit that receives the photo from the terminal apparatus; an object information acquiring unit that recognizes one or more objects through image recognition processing on the photo, acquires object identifiers for respectively identifying the one or more objects, and acquires one or more pieces of object information respectively containing the object identifiers; a presentation information acquiring unit that acquires recommendation information for making a recommendation for a user, using the acquired one or more pieces of object information; and a presentation information transmitting unit that transmits the recommendation information to the terminal apparatus. Accordingly, it is possible to recommend information using a captured photo.

### TECHNICAL FIELD

The present invention relates to a server apparatus and the like for recognizing an object in an image, and presenting information using a result of the recognition.

### BACKGROUND ART

Conventionally, there are techniques related to methods for searching for a product that a user wants. Also, there are coordination methods in which intentions of a provider of a first product can be reflected during a search for a second product that is to be combined with the first product (see Patent Document 1, for example).

Furthermore, conventionally, there are techniques for, in response to input of an image, searching for an image that is similar to the image (see Non-Patent Document 1, for example).

### CITATION LIST

### Patent Document

Patent Document 1: JP 2016-33708A (p. 1, FIG. 1, etc.)

### Non-Patent Document

Non-Patent Document 1: “Google Image Search”, [online], [accessed on Jun. 6, 2016], the Internet [URL: https://www.google.co.jp/imghp]

### SUMMARY OF INVENTION

### Technical Problem

However, according to such conventional techniques, in order to search for a product that a user wants, for example, it is necessary to find a desired product by transmitting a keyword expressed using a character string, a word, or the like to a search engine, or by narrowing down the category based on product category information or the like set by a product information provider.

Furthermore, according to the conventional technique of Patent Document 1, through electronic commerce, character string information indicating a product purchase instruction or the like is received, and recommendation information (a result of coordination processing) is acquired using the character string information and transmitted to a client terminal.

Furthermore, the conventional technique of Non-Patent Document 1 merely searches for an image that is similar to an input image. That is to say, according to the conventional technique, it is not possible to search for information on products and the like whose names are not known to users or that cannot be expressed by words. According to the conventional technique, it is not possible to specify product information using images such as photos, or to provide recommendation related to the product.

Thus, it is an object of the present invention to perform image recognition on a received image, acquire information using the recognition result, and present the information. In the present invention, it is assumed that, for example, a product itself that a user wants, or a product based on which another product related thereto is to be searched for appears in a received image. It will be appreciated that the technique according to the present invention is, for example, a technique for recognizing an object appearing in an image such as a photo, and presenting product information describing the object or allowing the object to be purchased, or a technique for presenting information based on an object appearing in an image such as a photo.

### Solution to Problem

A first aspect of the present invention is directed to an information system including a server apparatus and a terminal apparatus, wherein the terminal apparatus includes: a terminal storage unit in which an image containing one or at least two objects is stored; a terminal transmitting unit that transmits the image to the server apparatus; a terminal receiving unit that receives presentation information, which is information that is to be presented to a user and is information related to a product; and a terminal output unit that outputs the presentation information, and the server apparatus includes: an image receiving unit that receives the image from the terminal apparatus; an object information acquiring unit that recognizes one or more objects through image recognition processing on the image received by the image receiving unit, acquires object identifiers for respectively identifying the one or more objects, and acquires one or more pieces of object information respectively containing the object identifiers; a presentation information acquiring unit that, using the one or more pieces of object information acquired by the object information acquiring unit, acquires, as presentation information, object information of an object that is related to an object identified with one object identifier contained in one of the one or more pieces of object information and that is of a type different from the object; and a presentation information transmitting unit that transmits the presentation information to the terminal apparatus.

With this configuration, it is possible to present information using a captured image or the like.

Furthermore, a second aspect of the present invention is directed to the information system according to the first aspect, wherein, in the server apparatus, the presentation information acquiring unit further acquires, as presentation information, object information of an object that is a same as an object identified with the one object identifier, or object information of an object that is of a same type as an object identified with the one object identifier.

With this configuration, it is possible to present information using a captured image or the like.

Furthermore, a third aspect of the present invention is directed to the information system according to the first or second aspect, wherein the server apparatus further includes an object information transmitting unit that transmits one or more pieces of object information acquired by the object information acquiring unit, the terminal apparatus further includes: a terminal receiving unit that receives one or more pieces of object information from the server apparatus; a terminal output unit that outputs the image and one or more object identifiers contained in the one or more pieces of object information; and a terminal accepting unit that accepts a user's operation on one or more object identifiers output by the terminal output unit, the terminal transmitting unit transmits operation information related to the operation accepted by the terminal accepting unit, to the server apparatus, the server apparatus further includes an operation information receiving unit that receives the operation information from the terminal apparatus, and the presentation information acquiring unit acquires presentation information that is to be presented to a user, using the operation information received by the operation information receiving unit.

With this configuration, it is possible to present information using a captured image or the like, through interaction with a user.

Furthermore, a fourth aspect of the present invention is directed to the information system according to any one of the first to third aspects, wherein the operation information has one object identifier selected by a user from among the one or more object identifiers output by the terminal output unit, and the presentation information acquiring unit acquires presentation information, using object information of an object identified with the one object identifier.

With this configuration, it is possible to present proper information using a captured image or the like, through interaction with a user.

Furthermore, a fifth aspect of the present invention is directed to the information system according to the fourth aspect, wherein the presentation information acquiring unit acquires, as presentation information, object information of an object that is related to an object identified with the one object identifier and that is of a type different from the object, or acquires, as presentation information, object information of an object that is a same as an object identified with the one object identifier, or object information of an object that is of a same type as an object identified with the one object identifier.

With this configuration, it is possible to present proper information using a captured image or the like, through interaction with a user.

Furthermore, a sixth aspect of the present invention is directed to the information system according to any one of the first to fifth aspects, wherein the image receiving unit receives, together with the image, additional information that is information other than the image, and the presentation information acquiring unit uses a different algorithm for acquiring presentation information, depending on the additional information.

With this configuration, it is possible to present extremely proper information using a captured image or the like, through interaction with a user.

Furthermore, a seventh aspect of the present invention is directed to the information system according to the sixth aspect, wherein the additional information contains camera information related to a camera that captured the image.

With this configuration, it is possible to present extremely proper information using a captured image or the like, through interaction with a user.

Furthermore, an eighth aspect of the present invention is directed to the information system according to the seventh aspect, wherein, in a case where the camera information is information indicating a selfie mode, the presentation information acquiring unit acquires, as presentation information, object information of an object that is of a type different from an object identified with the one object identifier, and, in a case where the camera information is information indicating a non-selfie mode, the presentation information acquiring unit acquires, as presentation information, object information of an object that is a same as or of a same type as an object identified with the one object identifier.

With this configuration, it is possible to present extremely proper information using a captured image or the like, through interaction with a user.

Furthermore, a ninth aspect of the present invention is directed to the information system according to any one of the first to eighth aspects, wherein the object information acquiring unit recognizes the two or more objects through image recognition processing using a technique called deep learning on the image received by the image receiving unit, acquires object identifiers for respectively identifying the two or more objects, and acquires two or more pieces of object information respectively containing the object identifiers.

Furthermore, a tenth aspect of the present invention is directed to the information system according to any one of the first to ninth aspects, wherein the terminal accepting unit accepts user's selection on presentation information output by the terminal output unit, the terminal transmitting unit transmits purchase information related to the user's selection accepted by the terminal accepting unit, to the server apparatus, and the server apparatus further includes: a purchase information receiving unit that receives the purchase information from the terminal apparatus; and a payment processing unit that performs payment processing, using the purchase information.

With this configuration, it is possible to present information using a captured image or the like, and to assist a user to purchase products, etc.

### Advantageous Effects of Invention

According to the information system of the present invention, it is possible to properly present information using images and the like.

### BRIEF DESCRIPTION OF DRAWINGS

FIG. 1 is a conceptual diagram of an information system A in Embodiment 1.

FIG. 2 is a block diagram of the information system A in the embodiment.

FIG. 3 is a flowchart illustrating an operation of a terminal apparatus 1 in the embodiment.

FIG. 4 is a flowchart illustrating an operation of a server apparatus 2 in the embodiment.

FIG. 5 is an example of a taken photo in the embodiment.

FIG. 6 is a diagram showing an output example in the embodiment.

FIG. 7 is a diagram showing an output example in the embodiment.

FIG. 8 is a diagram showing an output example in the embodiment.

FIG. 9 is an example of a taken photo in the embodiment.

FIG. 10 is a diagram showing an output example in the embodiment.

FIG. 11 is a diagram showing an output example in the embodiment.

FIG. 12 is a schematic view of a computer system in the embodiment.

FIG. 13 is a block diagram of the computer system in the embodiment.

### DESCRIPTION OF EMBODIMENT

Hereinafter, embodiments of an information system and the like will be described with reference to the drawings. It should be noted that constituent elements denoted by the same reference numerals in the embodiments perform similar operations, and thus a description thereof may not be repeated.

### Embodiment 1

In this embodiment, a description will be given of an information system including a server apparatus that recognizes one or more objects in a received image (typically, a photo), acquires identifiers of the one or more objects, and transmits presentation information acquired using the one or more object identifiers, to a terminal apparatus. In this example, the presentation information is, for example, information on an object that is of a type different from an object (e.g., a jacket) in a received image. The presentation information is, for example, product information on an object (e.g., pants) that is of a type different from an object (e.g., a jacket) in a received image and that goes with the object in the image. The presentation information is, for example, product information on an object that is the same as or of the same type as an object (e.g., a jacket) in a received image.

Furthermore, in this embodiment, a description will be given of an information system including a server apparatus that transmits a recognition result of an object to a terminal apparatus, and, when the terminal apparatus accepts selection of an object from a user, transmits presentation information appropriate to the selected object to the terminal apparatus.

Furthermore, in this embodiment, a description will be given of an information system that uses a different algorithm for acquiring presentation information, depending on additional information such as a camera mode. That is to say, examples of the algorithm include, depending on additional information, an “I want it!” algorithm for acquiring information on an object that is the same as an object in an image, as presentation information, and a “coordinate” algorithm for acquiring information on an object that is of a type different from an object in an image, as presentation information. The “I want it!” algorithm is, for example, an algorithm for presenting an object that is the same as an object selected by a user in an image, but also may be an algorithm for acquiring information on an object that is of the same type as an object in an image, as presentation information. The “coordinate” algorithm is, for example, an algorithm for presenting a (coordinated) object that goes with an object selected by a user in an image and that is of a type different from the object.

Furthermore, in this embodiment, a description will be given of an information system that uses, for example, a technique called deep learning or other image analysis techniques in order to recognize an object.

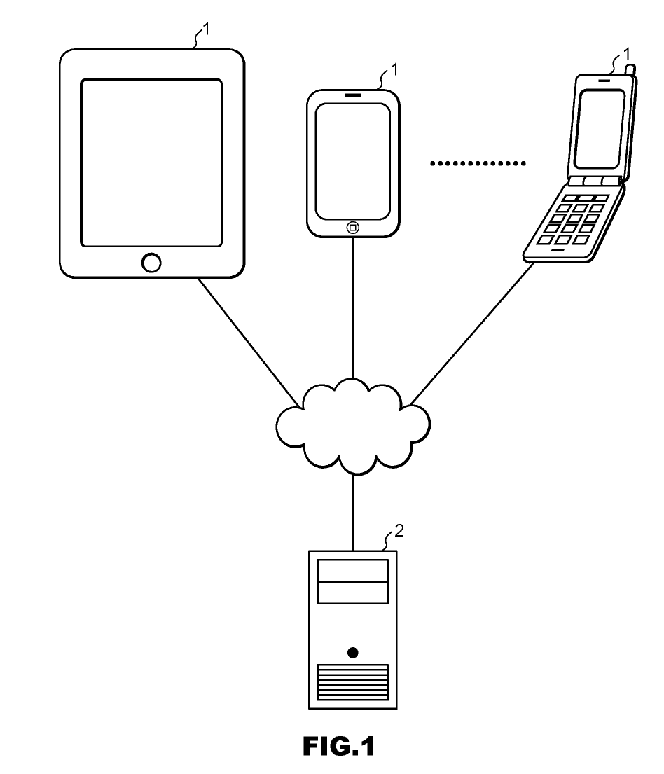

FIG. 1 is a conceptual diagram of the information system A in this embodiment. The information system A includes one or at least two terminal apparatuses 1 and a server apparatus 2. Each terminal apparatus 1 is, for example, a smartphone, a tablet device, a so-called personal computer, a mobile phone, or the like. The terminal apparatus 1 preferably has a photograph function. There is no limitation on the type of the terminal apparatus 1. The server apparatus 2 is a so-called cloud server or the like, and there is no limitation on the type thereof.

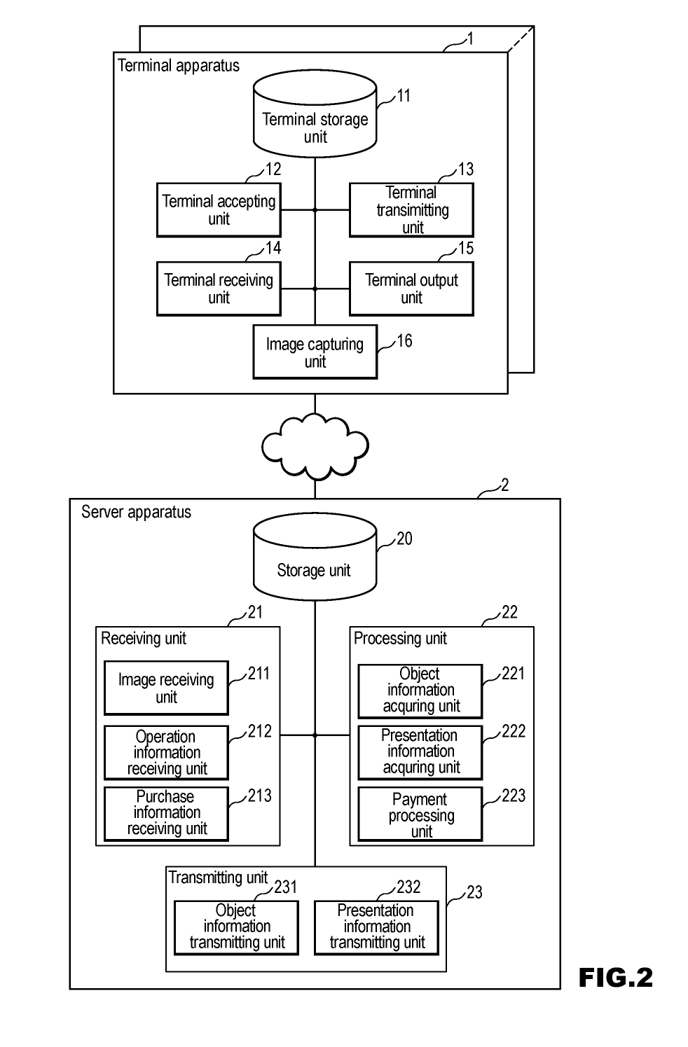

FIG. 2 is a block diagram of the information system A in this embodiment.

The terminal apparatus 1 constituting the information system A includes a terminal storage unit 11, a terminal accepting unit 12, a terminal transmitting unit 13, a terminal receiving unit 14, a terminal output unit 15, and an image capturing unit 16.

The server apparatus 2 includes a storage unit 20, a receiving unit 21, a processing unit 22, and a transmitting unit 23. The receiving unit 21 includes an image receiving unit 211, an operation information receiving unit 212, and a purchase information receiving unit 213. The processing unit 22 includes an object information acquiring unit 221, a presentation information acquiring unit 222, and a payment processing unit 223. The transmitting unit 23 includes an object information transmitting unit 231, and a presentation information transmitting unit 232.

In the terminal storage unit 11 constituting the terminal apparatus 1, various types of information is stored. The various types of information is, for example, an image containing one or at least two objects. The image containing an object is an image in which the object appears. The image containing an object is, for example, a photo or the like in which the object appears. The image is typically a taken photo. The image is an image that is transmitted to the server apparatus 2. There is no limitation on the object. The object is, for example, an article such as a jacket, a T-shirt, pants, shoes, or the like. The image is, for example, a photo related to real estate such as an indoor scene, a living environment in the neighborhood, or the like. In this case, the object is, for example, an indoor object (furniture, electrical equipment, etc.), a house appearing in a photo, a natural object (e.g., a mountain, a forest, etc.), or the like. The image is, for example, a photo related to a meal or a restaurant, such as food, food presentation, a cooking method, an indoor scene, or the like. In this case, the object is, for example, food, cuisine, a dish, a table at a restaurant, a chair, or the like. The image is, for example, a photo related to accommodation, a trip, or leisure, such as a view, an attraction, or the like. In this case, the object is, for example, an amusement park ride, a natural object appearing in a photo, or the like. There is no limitation on the image, and other examples thereof include images of a car, a person, and the like. The various types of information is, for example, later-described additional information, a user identifier for identifying a user, or the like. The user identifier may be information for identifying a terminal apparatus 1. The user identifier is, for example, an ID, a telephone number, an e-mail address, an IP address, a MAC address, browser cookie information, or the like.

The terminal accepting unit 12 accepts various types of information or instructions. The terminal accepting unit 12 accepts, for example, a user's operation on one or more object identifiers output by the terminal output unit 15. The user's operation on one or more object identifiers is typically an instruction to select an object. The terminal accepting unit 12 accepts user's selection on presentation information output by the terminal output unit 15. Other examples of the various types of information or instructions include an image capturing instruction to capture an image, a transmitting instruction to transmit an image, and the like. The terminal accepting unit 12 may accept, for example, an instruction on a URL, which is a type of presentation information. In this case, a web page specified with the URL is downloaded to the terminal apparatus 1.

The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory, and the like.

The various types of information or instructions may be input via any part such as a touch panel, a keyboard, a mouse, a menu screen, or the like. The terminal accepting unit 12 may be realized by a device driver for an input part such as a touch panel or a keyboard, or control software for a menu screen, for example.

The terminal transmitting unit 13 transmits an image to the server apparatus 2. The image may be a photo taken by the image capturing unit 16 and temporarily stored in the terminal storage unit 11, an image stored in advance in the terminal storage unit 11, or the like. The image is typically a still image, but also may be a moving image. When the image capturing unit 16 acquires an image through image capturing, the terminal transmitting unit 13 preferably immediately (without a user instruction) transmits the image to the server apparatus 2. Note that, after the image capturing unit 16 acquires an image through image capturing, the terminal transmitting unit 13 may transmit the image to the server apparatus 2, based on a user instruction.

The terminal transmitting unit 13 may transmit additional information as well to the server apparatus 2. The additional information is information other than the image. The additional information is information such as, for example, camera information such as a camera mode, a flag indicating which algorithm is to be used, a user instruction indicating which algorithm is to be used, or the like. The additional information is preferably transmitted together with an image, but does not have to be transmitted together with an image. That is to say, there is no limitation on the time to transmit the additional information. If the terminal transmitting unit 13 transmits additional information as well, the terminal transmitting unit 13 acquires the additional information in the terminal storage unit 11. The additional information is, for example, GPS-based positional information, an image capture time, information indicating where the photo has been uploaded, such as Facebook (registered trademark) or Instagram (registered trademark), an ID of a user who has shared the photo, the “Like!” count, or the like. The camera information may be information other than a camera mode, for example, such as a zoom magnification, exposure, a shutter speed, or the like. The terminal apparatus 1 typically has an additional information acquiring part (not shown) for acquiring additional information. The additional information acquiring part is, for example, a GPS receiver, a clock, an MPU and software for acquiring information indicating where the photo has been uploaded, or the like.

The terminal transmitting unit 13 transmits the operation information to the server apparatus 2. The operation information is information related to an operation accepted by the terminal accepting unit 12. The operation information has, for example, one object identifier selected by the user from among the one or more object identifiers output by the terminal output unit 15. The operation information may have only an object identifier of one object selected by the user. The operation information preferably has a user identifier. The operation information may have object identifiers of two or more objects selected by the user.

The terminal transmitting unit 13 transmits purchase information to the server apparatus 2. The purchase information is information related to a product that is to be purchased by the user. The purchase information is information related to user's selection accepted by the terminal accepting unit 12. The purchase information is information necessary to pay for a purchase. The purchase information has, for example, a product identifier of a product on which a purchase instruction was given by the user and the quantity thereof. The purchase information typically has a user identifier. In this example, the product may be considered as also including a so-called service. The product is typically those for sale. The product may be those not for sale, such as free contents that are to be browsed.

The terminal receiving unit 14 receives one or more pieces of object information from the server apparatus 2. The object information is information related to an object, and includes an object identifier. The object identifier is typically information indicating the type of object (e.g., a jacket, pants, etc.). That is to say, the object identifier does not have to be information for uniquely identifying an object. The object identifier may be information for uniquely identifying an object. The object information may have only an object identifier. The object information may contain, for example, positional information related to the position of an object in an image. The positional information may be information indicating the region of an object in an image. The positional information is, for example, one or two relative coordinate values indicating the position of an object in an image.

Furthermore, the terminal receiving unit 14 receives presentation information from the server apparatus 2. The presentation information is information that is to be presented to the user and is information related to a product. The presentation information may be recommendation information for to providing recommendations to the user. The presentation information may be information of a search result. The information related to a product is, for example, a screen for purchasing a product, a web page on which a product can be purchased, a URL of a web page on which a product can be purchased, a web page on which a product can be browsed, a URL of a web page on which a product can be browsed, information on specifications of a product, or the like.

The terminal output unit 15 outputs an image and one or more object identifiers. There is no limitation on the output mode of an image and one or more object identifiers. The terminal output unit 15 preferably outputs one or more object identifiers in an image. The terminal output unit 15 outputs, for example, one or more object identifiers in an image at the positions indicated by the positional information of the object identifiers contained in the one or more pieces of object information.

Furthermore, the terminal output unit 15 outputs the presentation information received by the terminal receiving unit 14. There is no limitation on the output mode of presentation information.

The output is typically display on a display screen, but is a concept that encompasses projection using a projector, printing by a printer, transmission to an external apparatus, accumulation in a storage medium, audio reading, delivery of a processing result to another processing apparatus or another program, and the like.

In the storage unit 20 constituting the server apparatus 2, various types of information can be stored. The various types of information is, for example, one or more pieces of product information, one or more pieces of user information, or the like. The product information is information related to a product or a service (hereinafter, referred to as products, etc.). The product information has, for example, a product identifier for identifying products, etc., and images, prices, features, attribute values (e.g., colors, sizes, shapes, etc.) or the like of products, etc. The product information is, for example, a web page on which a product is introduced or purchased. There is no limitation on the structure of the product information. The product information may be in an external server apparatus. In the storage unit 20, information (e.g., a URL, an IP address, an API, etc.) for accessing an external server apparatus may be stored. In this case, an external server apparatus is accessed using information for accessing the external server apparatus, and product information and the like are acquired by the server apparatus 2. The information for accessing an external server apparatus may be considered as product information. In this case, the product information is, for example, a URL of a web page on which a product is introduced or purchased.

The user information is information related to a user. The user information has, for example, a user identifier, a full name, an age, a sex, an address, a telephone number, an e-mail address, an SNS ID, or the like.

The receiving unit 21 receives various types of information or instructions from the terminal apparatus 1. The various types of information or instructions are, for example, an image, additional information, purchase information, or the like.

The image receiving unit 211 receives an image (e.g., a photo) containing one or at least two objects from the terminal apparatus 1. The image receiving unit 211 preferably receives, together with an image, additional information that is information other than the image. There is no limitation on the time at which the image receiving unit 211 receives additional information. The image receiving unit 211 may receive additional information together with an image, or, for example, may receive additional information together with a selected object after receiving an image.

The operation information receiving unit 212 receives operation information related to an operation performed by a user, from the terminal apparatus 1. The operation information has, for example, an object identifier.

The purchase information receiving unit 213 receives purchase information from the terminal apparatus 1. The purchase information has, for example, a product identifier, a quantity, a user identifier, and the like.

The processing unit 22 performs various types of processing. The various types of processing is for example, processing that is performed by the object information acquiring unit 221, the presentation information acquiring unit 222, the payment processing unit 223, or the like.

The object information acquiring unit 221 recognizes one or at least two objects through image recognition processing on an image received by the image receiving unit 211, acquires object identifiers for identifying the one or at least two objects, and acquires one or at least two pieces of object information containing the object identifiers.

The object information acquiring unit 221 may recognize one or at least two objects through image recognition processing using a technique called deep learning, edge detection, or other image recognition techniques or artificial intelligence techniques on an image received by the receiving unit 21, acquire object identifiers for identifying the one or at least two objects, and acquire one or at least two pieces of object information containing the object identifiers. The image recognition processing using deep learning is a known technique, and thus a detailed description thereof has been omitted. The object information acquiring unit 221 may recognize an object also using information added to an image received by the image receiving unit 211. In this example, the added information is the above-described additional information, such as positional information indicating a position, time information indicating a time, or the like It is also preferable that the object recognition using the added information uses, for example, artificial intelligence techniques such as deep learning.

For example, if an image is a photo, and positional information indicating a position at which the photo was taken is the additional information, the object information acquiring unit 221 acquires object information through sorting in order in which the positional information corresponding to the recognized object is closer to the positional information that is the additional information. In this case, it is assumed that the positional information corresponding to objects is managed in association with the object information.

Furthermore, if an object that is acquired is a photo that has been uploaded to an SNS server (e.g., Instagram (registered trademark) or Facebook (registered trademark)), and information indicating reaction (e.g., information indicating “Like”) to the photo or posted information (which may be referred to as an article) containing the photo is the additional information, the object information acquiring unit 221 preferably acquires object information in descending order of the “Like!” count. In this case, it is assumed that the object information acquiring unit 221 acquires information indicating reaction to the photo or posted information containing the photo, from the SNS server. The processing for acquiring such information indicating reaction is a known technique, and thus a detailed description thereof has been omitted.

There is no limitation on the algorithm in which the object information acquiring unit 221 acquires one or more object identifiers. For example, in a state in which one or more pairs of an object image and an object identifier are stored in the storage unit 20, the object information acquiring unit 221 may extract a contour in an image, further extract regions of one or more objects based on the contour, calculate similarities between one or more images (partial images) in the extracted regions and images in the storage unit 20, and acquire, for each of the one or more partial images in the extracted regions, an object identifier that is paired with an image in the storage unit 20 with the largest similarity. The object information acquiring unit 221 preferably acquires positional information for specifying the position of an extracted region.

Using the one or more pieces of object information acquired by the object information acquiring unit 221, the presentation information acquiring unit 222 acquires, as presentation information, object information of an object that is related to an object identified with one object identifier contained in one of the one or more pieces of object information and that is of a type different from the object. The presentation information acquiring unit 222 may acquire presentation information that is to be presented to the user, using the one or more pieces of object information acquired by the object information acquiring unit 221. It is also possible that, using the one or more pieces of object information acquired by the object information acquiring unit 221, the presentation information acquiring unit 222 further acquires, as presentation information, object information of an object that is the same as an object identified with an object identifier contained in one of the one or more pieces of object information, or object information of an object that is of the same type as an object identified with the one object identifier. There is no limitation on the algorithm in which the presentation information acquiring unit 222 acquires presentation information. The presentation information acquiring unit 222 searches for, for example, product information in the storage unit 20 using, as a key, an object identifier contained in the object information acquired by the object information acquiring unit 221, thereby acquiring one or more pieces of product information, and acquires presentation information having the whole or part of the one or more pieces of product information. The presentation information acquiring unit 222 acquires, for example, one or more feature values (e.g., color, etc.) of a partial image corresponding to an object identifier contained in the object information acquired by the object information acquiring unit 221, acquires one or more pieces of product information from the storage unit 20 using the one or more feature values, and acquires presentation information having the whole or part of the one or more pieces of product information. The presentation information acquiring unit 222 acquires, for example, product information (stored in the storage unit 20) corresponding to an image that is most similar to a partial image corresponding to an object identifier contained in the object information acquired by the object information acquiring unit 221, and acquires presentation information using product information of one or more products that are purchased very often by people who purchase the product indicated by the product information. That is to say, the presentation information acquiring unit 222 may acquire presentation information using a known algorithm such as collaborative filtering. The presentation information acquiring unit 222 may acquire presentation information, for example, using the recommending techniques described in Japanese Patent Nos. 5064063 and 5140289, for example. Furthermore, the presentation information acquiring unit 222 may acquire two or more pieces of presentation information by simultaneously executing both the “coordinate” algorithm and the “I want it!” algorithm.

Furthermore, the presentation information acquiring unit 222 may acquire presentation information using in different manners either one of the “coordinate” algorithm and the “I want it!” algorithm. There is no limitation on the condition for using in different manners the “coordinate” algorithm and the “I want it!” algorithm. The condition is, for example, a user instruction received from the terminal apparatus 1. The condition is, for example, additional information.

Furthermore, the presentation information acquiring unit 222 may acquire presentation information for an object, using additional information added to an image received by the image receiving unit 211.

The presentation information acquiring unit 222 acquires presentation information that is to be presented to the user, using the operation information received by the operation information receiving unit 212. The presentation information acquiring unit 222 preferably acquires presentation information, using an object identifier contained in the operation information received by the operation information receiving unit 212. The presentation information acquiring unit 222 may acquire presentation information, for example, by executing the above-described algorithm or the like, using an object identifier contained in the operation information received by the operation information receiving unit 212.

If the operation information contains two or more object identifiers, the presentation information acquiring unit 222 preferably acquires presentation information, using the two or more object identifiers.

The presentation information acquiring unit 222 acquires, as presentation information, object information of an object that is of a type different from an object identified with one object identifier contained in the operation information received by the operation information receiving unit 212, for example. In this example, the one object identifier is typically an object identifier contained in operation information (an identifier of an object selected by a user). The algorithm for this processing is the “coordinate” algorithm. More specifically, for example, using an algorithm that “coordinate” an object that is of a type different from an object identifier contained in the operation information received by the operation information receiving unit 212, the presentation information acquiring unit 222 acquires one or more feature values of an image of an object identified with the object identifier, and acquires presentation information of an object (e.g., pants) that is of a type different from an object (e.g., a jacket) and that goes with (matches in terms of design) the object, using the one or more feature values.

The presentation information acquiring unit 222 realizes the above-described “coordinate” algorithm, for example, as follows. That is to say, the presentation information acquiring unit 222 acquires a recommended object group related to an object identified with an object identifier contained in the operation information, for the user of the terminal apparatus 1, for example, using a known recommending technique, and acquires object information identified with an object identifier that is of a type different from an object identifier contained in the operation information, from among the group. The known recommending technique is, for example, collaborative filtering, the recommending techniques described in Japanese Patent Nos. 5064063 and 5140289, for example, or the technique described in books such as “Recommender Systems: An Introduction—Theory and Practice—(Kyoritsu Shuppan Co., Ltd.)”. The presentation information acquiring unit 222 preferably acquires object information an object that is of a type different from an object identified with an object identifier contained in the operation information, using a user behavior history (user's product purchase history, etc.) of the user of the terminal apparatus 1. It will be appreciated that there is no limitation on the algorithm in which the presentation information acquiring unit 222 acquires object information. In the “coordinate” algorithm, it is sufficient that the presentation information acquiring unit 222 acquires object information of an object that is of a type different from an object identified with an object identifier contained in the operation information. That is to say, the presentation information acquiring unit 222 does not have to acquire object information of an object that is of a type different from an object identified with an object identifier contained in the operation information and that goes with the object in terms of design. The presentation information may contain product information, or may be a URL or the like for accessing an external apparatus.

The presentation information acquiring unit 222 acquires, as presentation information, object information of an object that is the same as an object identified with one object identifier, for example. In this example, one object identifier is typically an object identifier contained in operation information. The algorithm for this processing is the “I want it!” algorithm. More specifically, the presentation information acquiring unit 222 performs image search, for example, using an image of an object identified with an object identifier contained in the operation information received by the operation information receiving unit 212, and acquires presentation information of an object that is the same as the object through application of the “I want it!” algorithm. This presentation information may contain product information, or may be a URL or the like for accessing an external apparatus.

Furthermore, the presentation information acquiring unit 222 acquires, as presentation information, object information of an object that is of the same type as an object identified with the one object identifier, for example. In this example, one object identifier is typically an object identifier contained in operation information. The algorithm for this processing is an algorithm obtained by expanding the “I want it!” algorithm.

The presentation information acquiring unit 222 preferably uses a different algorithm for acquiring presentation information, depending on the additional information.

In this example, a different algorithm is, for example, the “I want it!” algorithm and the “coordinate” algorithm. The “I want it!” algorithm is, for example, an algorithm for acquiring, as presentation information, object information of an object that is the same as an object identified with one object identifier selected by a user. The “I want it!” algorithm is, for example, an algorithm for acquiring object information acquired by the object information acquiring unit 221, or for acquiring object information that is of the same type as an object identified with one object identifier selected by a user. The “coordinate” algorithm is an algorithm for acquiring, as presentation information, object information of an object that is of a type different from an object identified with one object identifier selected by a user and that goes with the object.

For example, if the camera information is information indicating a selfie mode, the presentation information acquiring unit 222 uses the “coordinate” algorithm. For example, if the camera information is information indicating a non-selfie mode (normal mode), the presentation information acquiring unit 222 uses the “I want it!” algorithm. The selfie mode is a mode in which the user of the terminal apparatus 1 appears in the display screen of the terminal apparatus 1, and is a mode in which the image-capturing direction of the camera is on the display screen side. The normal mode is a mode in which the image-capturing direction of the camera is opposite to that in the selfie mode, and is a mode in which the image-capturing direction is on the rear face side of the terminal apparatus 1.

The payment processing unit 223 performs payment processing, using received purchase information. There is no limitation on the payment processing, as long as it is processing for payment. The payment processing unit 223 may perform processing, for example, for transmitting purchase information to a payment server of a credit card company. The payment processing unit 223 may process affiliate information. The processing of affiliate information is for example, processing that transmits an affiliate ID and the like to a server apparatus or the like managing affiliates when a user instructs (typically, clicks on) an affiliate link output to the terminal apparatus 1. An affiliate ID is an ID issued from a company managing affiliates, and an affiliate link is typically a URL obtained by combining presentation information and an affiliate ID. The payment processing unit 223 may perform processing, for example, for storing purchase information in association with information on the user. The payment processing is a known technique, and thus a detailed description thereof has been omitted.

The transmitting unit 23 transmits various types of information to a terminal apparatus. The various types of information is, for example, object information or presentation information.

The object information transmitting unit 231 transmits the one or more pieces of object information acquired by the object information acquiring unit 221, to the terminal apparatus 1.

The presentation information transmitting unit 232 transmits the presentation information acquired by the presentation information acquiring unit 222, to the terminal apparatus 1. The presentation information typically contains one or at least two pieces of product information.

The terminal storage unit 11 and the storage unit 20 are preferably non-volatile storage media, but may be realized also by volatile storage media. There is no limitation on the procedure in which the information is stored in the terminal storage unit 11 and the like. For example, the information may be stored in the terminal storage unit 11 and the like via a storage medium, the information transmitted via a communication line or the like may be stored in the terminal storage unit 11 and the like, or the information input via an input device may be stored in the terminal storage unit 11 and the like.

The terminal transmitting unit 13, the transmitting unit 23, the object information transmitting unit 231, and the presentation information transmitting unit 232 are realized typically by wireless or wired communication parts, but may be realized also by broadcasting parts.

The terminal receiving unit 14, the receiving unit 21, the image receiving unit 211, the operation information receiving unit 212, and the purchase information receiving unit 213 are realized typically by wireless or wired communication parts, but may be realized also by broadcast receiving parts.

The terminal output unit 15 may be considered to include or not to include an output device, such as a display screen or a speaker. The terminal output unit 15 may be realized, for example, by driver software for an output device, a combination of driver software for an output device and the output device, or the like.

The processing unit 22, the object information acquiring unit 221, the presentation information acquiring unit 222, and the payment processing unit 223 may be realized typically by MPUs, memories, or the like. Typically, the processing procedure of the processing unit 22 and the like is realized by software, and the software is stored in a storage medium such as a ROM. Note that the processing procedure may be realized also by hardware (dedicated circuits).

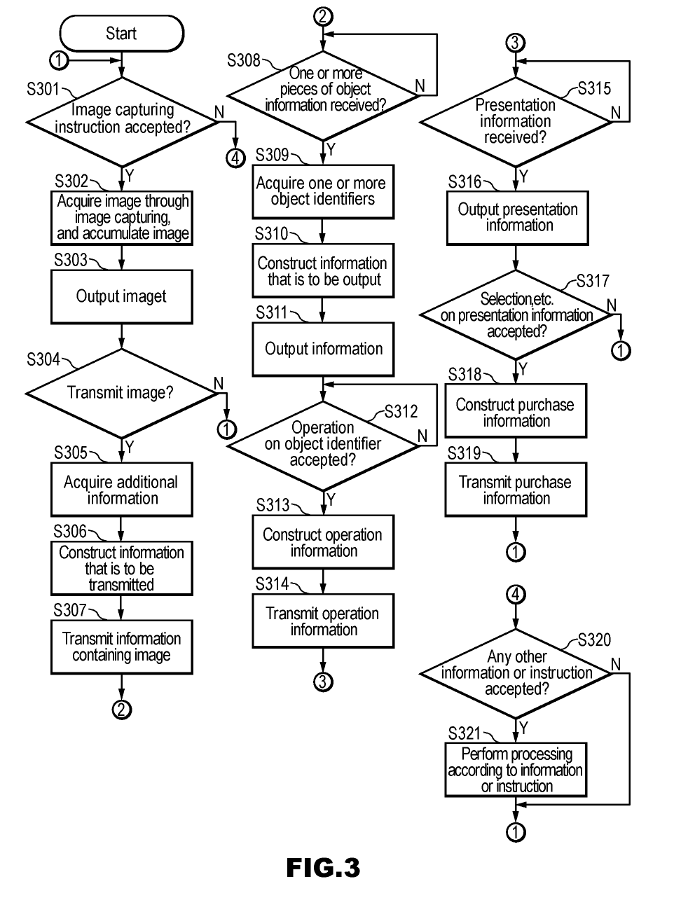

Next, an operation of the information system A will be described. First, an operation of the terminal apparatus 1 will be described with reference to the flowchart in FIG. 3.

(Step S301) The terminal accepting unit 12 determines whether or not an image capturing instruction has been accepted. If an image capturing instruction has been accepted, the procedure advances to step S302, and, if not, the procedure advances to step S320.

(Step S302) The image capturing unit 16 acquires an image through image capturing. The image capturing unit 16 at least temporarily stores the captured image in the terminal storage unit 11.

(Step S303) The terminal output unit 15 outputs the image (photo, in this example) acquired in step S302.

(Step S304) A terminal processing unit (not shown) of the terminal apparatus 1 determines whether or not to transmit the image. If it is determined to transmit an image, the procedure advances to step S305, and, if not, the procedure returns to step S301. The terminal processing unit checks the flag stored in the terminal storage unit 11. If the flag is information indicating that an image is to be transmitted, the terminal processing unit transmits the image, and, if not, the terminal processing unit does not transmit the image. It is also possible that, if an image is acquired in step S302, the terminal transmitting unit 13 of the terminal apparatus 1 automatically transmits the image to the server apparatus 2. It is also possible that, if the terminal accepting unit 12 accepts a transmitting instruction from a user, an image is transmitted.

(Step S305) The terminal transmitting unit 13 acquires additional information stored in the terminal storage unit 11. The additional information is, for example, a camera mode.

(Step S306) The terminal transmitting unit 13 constructs information that is to be transmitted, using the image acquired in step S302 and the additional information acquired in step S305. The terminal transmitting unit 13 may construct information that is to be transmitted, using the image acquired in step S302 but not using the additional information.

(Step S307) The terminal transmitting unit 13 transmits the information constructed in step S306, to the server apparatus 2. In the terminal storage unit 11, typically, information (e.g., an IP address or a URL of the server apparatus 2, etc.) for communicating with the server apparatus 2 is stored.

(Step S308) The terminal receiving unit 14 determines whether or not one or more pieces of object information have been received from the server apparatus 2. If one or more pieces of object information have been received, the procedure advances to step S309, and, if not, the procedure returns to step S308. When a predetermined period of time or more has elapsed after the information is transmitted in step S307, the procedure preferably returns to step S301 due to timeout.

(Step S309) The terminal output unit 15 acquires one or more object identifiers from the one or more pieces of object information acquired in step S308.

(Step S310) The terminal output unit 15 constructs information that is to be output, using the one or more object identifiers acquired in step S309. The terminal output unit 15 preferably constructs information that is to be output, using the in-image positional information contained in the one or more pieces of object information, such that the one or more object identifiers are output to proper positions in the image.

(Step S311) The terminal output unit 15 outputs the information constructed in step S310. In this example, the terminal output unit 15 preferably outputs the information constructed in step S310 containing the one or more object identifiers, in the image output in step S303.

(Step S312) The terminal accepting unit 12 determines whether or not an operation on the one or more object identifiers output in step S311 have been accepted. If an operation has been accepted, the procedure advances to step S313, and, if not, the procedure returns to step S312. When a predetermined period of time or more has elapsed after the information is output in step S311, the procedure preferably returns to step S301 due to timeout. The operation is typically an operation for selecting one object identifier from among the one or more object identifiers that have been output.

(Step S313) The terminal transmitting unit 13 constructs operation information, based on the operation accepted in step S312. The operation information typically has the one object identifier selected in step S312.

(Step S314) The terminal transmitting unit 13 transmits the operation information constructed in step S313, to the server apparatus 2.

(Step S315) The terminal receiving unit 14 determines whether or not presentation information has been received from the server apparatus 2. If presentation information has been received, the procedure advances to step S316, and, if not, the procedure returns to step S315. When a predetermined period of time or more has elapsed after the operation information is transmitted in step S314, the procedure preferably returns to step S301 due to timeout.

(Step S316) The terminal output unit 15 outputs the presentation information received in step S315.

(Step S317) The terminal accepting unit 12 determines whether or not user's selection on the presentation information output in step S316 has been accepted. If user's selection has been accepted, the procedure advances to step S318, and, if not, the procedure returns to step S301.

(Step S318) The terminal transmitting unit 13 constructs purchase information, based on the user's selection accepted in step S317.

(Step S319) The terminal transmitting unit 13 transmits purchase information to the server apparatus 2. The procedure returns to step S301.

(Step S320) The terminal accepting unit 12 determines whether or not any other information or instruction has been accepted. If any other information or instruction has been accepted, the procedure advances to step S321, and, if not, the procedure returns to step S301.

(Step S321) The terminal processing unit (not shown) performs processing according to the other information or instruction.

In the flowchart in FIG. 3, presentation information may be received even if an object identifier has not been selected by the user. The state in which an object identifier has not been selected by the user refers to a state in which operation information is not transmitted to the server apparatus 2.

Note that the procedure is terminated by powering off or an interruption at the end of the process in the flowchart in in FIG. 3.

In step S307 of the flowchart in FIG. 3, a captured image is transmitted to the server apparatus 2. However, in step S307, an image stored in the terminal storage unit 11 may be transmitted to the server apparatus 2. The image stored in the terminal storage unit 11 is, for example, photos stored in advance in the terminal apparatus 1, photos acquired from web pages, photos downloaded from SNSs, or the like.

In the flowchart in FIG. 3, after one or more pieces of object information are received from the server apparatus 2 (S308), presentation information, which is one or more pieces of object information, may be output (S316) without displaying an object identifier indicating the type of object. In particular, in the case of using the “I want it!” algorithm, the terminal apparatus 1 preferably performs such an operation.

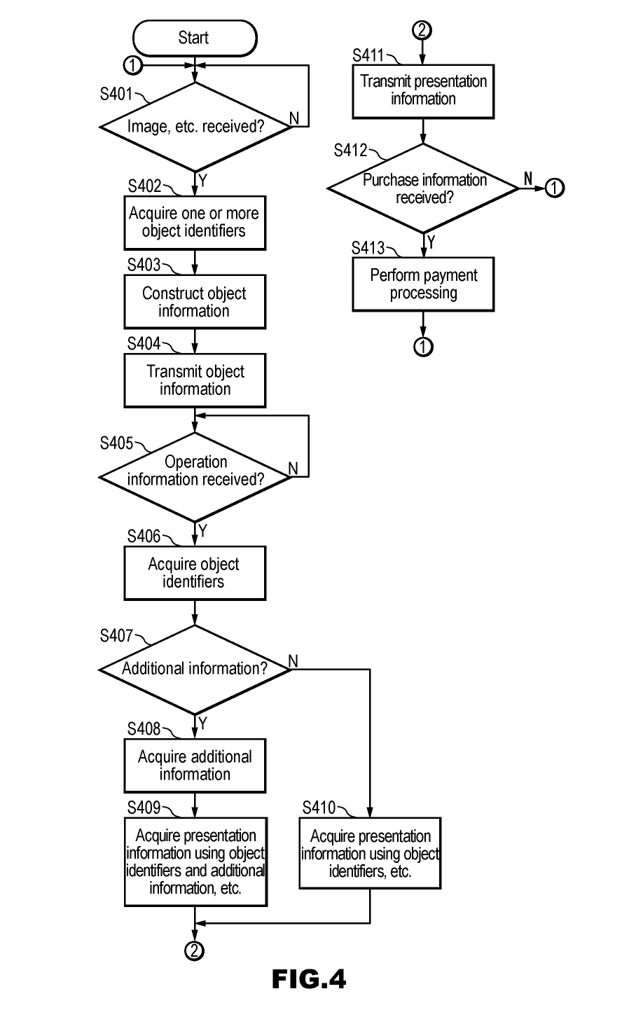

Next, an operation of the server apparatus 2 will be described with reference to the flowchart in FIG. 4.

(Step S401) The image receiving unit 211 determines whether or not an image and the like have been received from the terminal apparatus 1. If an image and the like have been received, the procedure advances to step S402, and, if not, the procedure returns to step S401. The image and the like are, for example, an image and additional information. The image and the like include, for example, a user identifier.

(Step S402) The object information acquiring unit 221 performs image recognition processing on the image received in step S401, recognizes one or more objects, and acquires object identifiers for identifying one or more objects.

(Step S403) The object information acquiring unit 221 constructs one or more pieces of object information, using the one or more object identifiers acquired in step S402.

(Step S404) The object information transmitting unit 231 transmits the one or more pieces of object information constructed in step S403, to the terminal apparatus 1 from which the image and the like were transmitted.

(Step S405) The operation information receiving unit 212 determines whether or not operation information has been received from the terminal apparatus 1. If operation information has been received, the procedure advances to step S406, and, if not, the procedure returns to step S405.

(Step S406) The presentation information acquiring unit 222 acquires one or more object identifiers, using the operation information received in step S405. In this example, the operation information may contain two or more object identifiers.

(Step S407) The presentation information acquiring unit 222 determines whether or not there is additional information in the image and the like received in step S401. If there is additional information, the procedure advances to step S408, and, if not, the procedure advances to step S410.

(Step S408) The presentation information acquiring unit 222 acquires additional information, from the image and the like received in step S401.

(Step S409) The presentation information acquiring unit 222 acquires presentation information, using the one or more object identifiers acquired in step S406, the additional information acquired in step S408, and the like. The procedure advances to step S411. For example, the presentation information acquiring unit 222 acquires presentation information, by using the “coordinate” algorithm if camera information, which is additional information, is information indicating a selfie mode, or by using the “I want it!” algorithm if camera information, which is additional information, is information indicating a non-selfie mode.

(Step S410) The presentation information acquiring unit 222 acquires presentation information, using the one or more object identifiers acquired in step S406 and the like. The presentation information acquiring unit 222 acquires presentation information, for example, using the “coordinate” algorithm or the “I want it!” algorithm.

(Step S411) The presentation information transmitting unit 232 transmits the acquired presentation information to the terminal apparatus 1.

(Step S412) The purchase information receiving unit 213 determines whether or not purchase information has been received from the terminal apparatus 1. If purchase information has been received, the procedure advances to step S413, and, if not, the procedure returns to step S401.

(Step S413) The payment processing unit 223 performs payment processing, using the purchase information received in step S412. The procedure returns to step S401.

In the flowchart in FIG. 4, after one or more object identifiers are acquired in step S402, the presentation information acquiring unit 222 may acquire presentation information using the one or more object identifiers. In this case, the processing from steps S403 to S406 may be omitted. Furthermore, in the flowchart in FIG. 4, if the image receiving unit 211 receives an image from the terminal apparatus 1, the object information acquiring unit 221 may perform object recognition in the image, and the presentation information acquiring unit 222 may search for object information of an object that is the same as the object, and construct presentation information containing the object information. The presentation information transmitting unit 232 may transmit the acquired presentation information to the terminal apparatus 1.

Note that the procedure is terminated by powering off or an interruption at the end of the process in the flowchart in FIG. 4.

Hereinafter, specific operations of the information system A in this embodiment will be described. FIG. 1 is a conceptual diagram of the information system A.

Hereinafter, four specific examples will be described. Specific Example 1 shows a case in which the server apparatus 2 acquires presentation information without using additional information, and transmits it to the terminal apparatus 1. Specific Example 2 shows a case in which the server apparatus 2 acquires presentation information using additional information indicating that the camera is in a selfie mode, and transmits it to the terminal apparatus 1. Specific Example 2 shows a case in which the “coordinate” algorithm is used. Specific Example 3 shows a case in which the server apparatus 2 acquires presentation information using additional information indicating that the camera is in a normal mode, and transmits it to the terminal apparatus 1. Specific Example 3 shows a case in which the “I want it!” algorithm is used. Specific Example 4 shows a case in which, after an image is transmitted from the terminal apparatus 1, the server apparatus 2 acquires an object identifier from the image, acquires presentation information using the object identifier, and transmits it to the terminal apparatus 1. That is to say, Specific Example 4 shows a case in which presentation information is transmitted from the server apparatus 2 to the terminal apparatus 1 merely by transmitting an image from the terminal apparatus 1, without interaction with the user.

### Specific Example 1

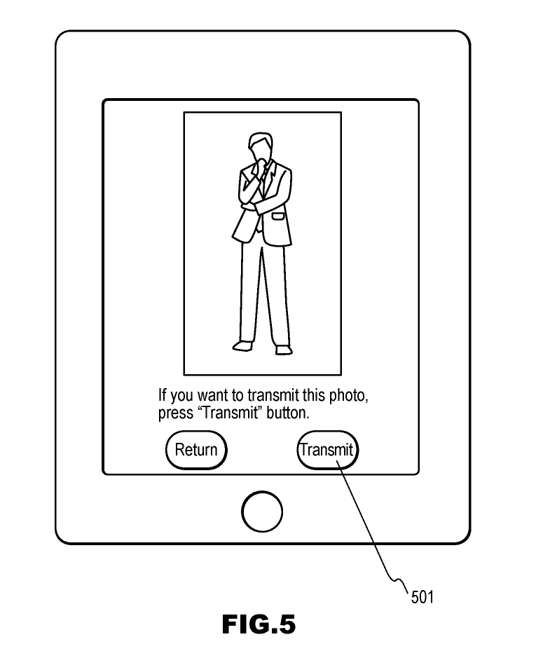

First, it is assumed that the user of a terminal apparatus 1 captures an image of a mannequin in clothes, using a camera of the terminal apparatus 1. That is to say, the terminal accepting unit 12 of the terminal apparatus 1 accepts an image capturing instruction. The image capturing unit 16 acquires a photo (an image) through image capturing, and temporarily stores the photo in the terminal storage unit 11. The terminal output unit 15 displays the acquired photo on the display screen. FIG. 5 shows such a photo.

Next, it is assumed that the user has input a photo transmitting instruction to transmit the photo displayed on the display screen, to the terminal apparatus 1 (has pressed a “Transmit” button 501). Next, the terminal accepting unit 12 accepts the photo transmitting instruction. The terminal transmitting unit 13 constructs information that is to be transmitted, using the photo corresponding to the photo transmitting instruction, and transmits the information.

Next, the image receiving unit 211 of the server apparatus 2 receives information containing the photo, from the terminal apparatus 1.

It is assumed that the object information acquiring unit 221 performs image recognition processing on the received photo, using an algorithm such as deep learning, recognizes four objects in the photo, and acquires object identifiers of the four objects (necktie, jacket, pants, shoes). The object identifiers are names of objects (e.g., products). The names of objects may be considered as types of objects. Note that the names of objects may be proper nouns.

Furthermore, the object information acquiring unit 221 acquires positional information indicating relative positions of the objects in the photo. The positional information may be, for example, information for specifying a region in which an object is present, or may be coordinate information of a feature point of a region in which an object is present (e.g., the upper left point or the center point in the region, etc.). In this example, it is assumed that the object information acquiring unit 221 has acquired positional information ((x₁₁,y₁₁) (x₁₂,y₁₂)) corresponding to the object identifier “necktie”, positional information ((x₂₁,y₂₁) (x₂₂,y₂₂)) corresponding to the object identifier “jacket”, positional information ((x₃₁,y₃₁) (x₃₂,y₃₂)) corresponding to the object identifier “pants”, and positional information ((x₄₁,y₄₁) (x₄₂,y₄₂)) corresponding to the object identifier “shoes”.

Next, the object information acquiring unit 221 constructs four pieces of object information, using the acquired four object identifiers (necktie, jacket, pants, shoes). The object information contains an object identifier and positional information.

Next, the object information transmitting unit 231 transmits the constructed four pieces of object information, to the terminal apparatus 1 from which the photo and the like were transmitted.

Next, the terminal receiving unit 14 of the terminal apparatus 1 receives the four pieces of object information from the server apparatus 2.

Next, the terminal output unit 15 acquires four object identifiers (necktie, jacket, pants, shoes) from the four pieces of object information.

Next, the terminal output unit 15 determines positions (positions in the photo) to which the object identifiers are to be output, using the positional information corresponding to the four object identifiers. There is no limitation on the method for determining the positions.

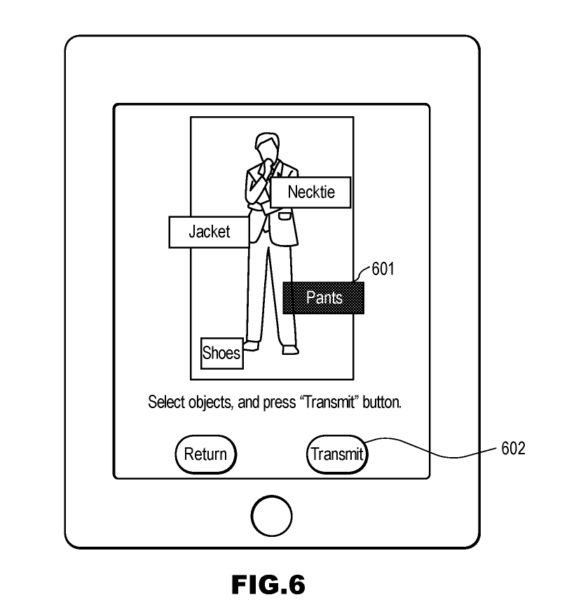

Next, the terminal output unit 15 outputs the four object identifiers to the determined positions in the photo. FIG. 6 shows such an output example.

Next, it is assumed that the user wants to purchase pants that are the same as or similar to the pants in the photo. It is assumed that the user has input an instruction to select “pants” from among the displayed four object identifiers. Then, the terminal accepting unit 12 of the terminal apparatus 1 accepts a selecting operation on “pants” among the output four object identifiers. The terminal output unit 15 changes the display mode such that the display of the object identifier “pants” can be visually distinguished from the other object identifiers. In this example, the terminal output unit 15 changes the display of the object identifier “pants” to display in an inverted color (see 601).

Next, it is assumed that the user has pressed a “Transmit” button (602) in FIG. 6. The terminal accepting unit 12 accepts an instruction to transmit the operation information. The terminal transmitting unit 13 constructs operation information containing the selected object identifier “pants”. Next, the terminal transmitting unit 13 transmits the operation information to the server apparatus 2.

Next, the operation information receiving unit 212 of the server apparatus 2 receives the operation information from the terminal apparatus 1.

Next, the presentation information acquiring unit 222 acquires an object identifier “pants” contained in the received operation information. The presentation information acquiring unit 222 acquires presentation information using the object identifier “pants”. In this example, the presentation information acquiring unit 222 acquires product information (not shown) on three pairs of pants that are paired with the object identifier “pants”, from the storage unit 20. The product information in this example has information such as a product image, a product name, a price, a product feature, and the like. The presentation information acquiring unit 222 constructs presentation information containing the product information on the three pairs of pants. It is assumed that presentation information has, in addition to the product information, a check box for selecting that purchase is to be made, a field for inputting a size, and the like. It is assumed that information and the like constituting user interfaces such as the check box and the field are stored in advance in the storage unit 20.

Next, the presentation information transmitting unit 232 transmits the constructed presentation information to the terminal apparatus 1.

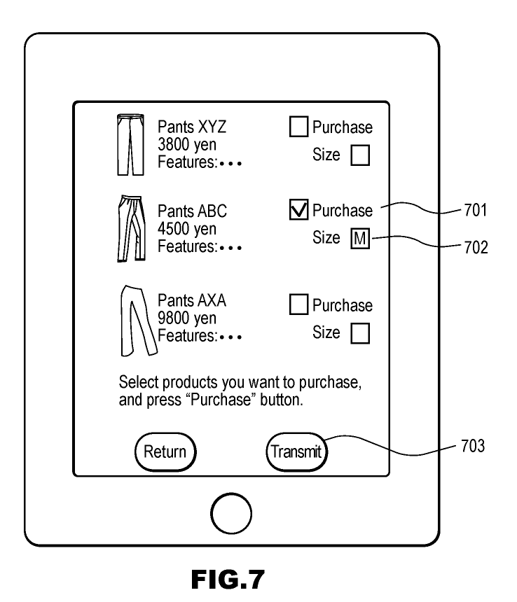

Next, the terminal receiving unit 14 of the terminal apparatus 1 receives the presentation information from the server apparatus 2. The terminal output unit 15 outputs the received presentation information. FIG. 7 shows such an output example.

Next, on the screen in FIG. 7, the user selects a product that he or she wants to purchase (701), inputs the size “M” (702), and presses a “Purchase” button 703. Then, the terminal accepting unit 12 accepts user's selection on the output presentation information. The terminal transmitting unit 13 constructs purchase information, based on the accepted user's selection. In this example, the purchase information has the identifier “Pants ABC” for identifying a product, the size “M”, the user identifier for identifying a user, and the like. It is assumed that the user identifier is stored, for example, in the terminal storage unit 11. Next, the terminal transmitting unit 13 transmits purchase information to the server apparatus 2.

Next, the purchase information receiving unit 213 of the server apparatus 2 receives the purchase information from the terminal apparatus 1. The payment processing unit 223 performs payment processing, using the received purchase information.

Through the above-described processing, it is possible to present product information using a photo, and to purchase a product. In Specific Example 1, the presentation information acquiring unit 222 may acquire product information (not shown) paired with the object identifier “pants”, and containing an image of pants that are determined as being the same as the pants in the image in FIG. 6, from the storage unit 20. In this case, presentation information containing one piece of product information is output to the terminal apparatus 1.

### Specific Example 2

First, it is assumed that the user of the terminal apparatus 1 sets the camera mode of the terminal apparatus 1 to a “selfie” mode. Then, the terminal accepting unit 12 accepts an instruction to set the camera mode to a “selfie” mode. The terminal processing unit (not shown) sets the camera mode to a “selfie” mode.

Next, it is assumed that the user of the terminal apparatus 1 captures an image of himself or herself using the camera of the terminal apparatus 1. That is to say, the terminal accepting unit 12 of the terminal apparatus 1 accepts an image capturing instruction. The image capturing unit 16 acquires a photo of the user through image capturing, and temporarily stores the photo in the terminal storage unit 11. The terminal output unit 15 displays the acquired photo on the display screen. FIG. 5 shows such a photo.

Next, it is assumed that the user has input a photo transmitting instruction to transmit the photo displayed on the display screen, to the terminal apparatus 1. Next, the terminal accepting unit 12 accepts the photo transmitting instruction. The terminal transmitting unit 13 constructs information that is to be transmitted, using the photo corresponding to the photo transmitting instruction, and transmits the information. The terminal transmitting unit 13 may acquire additional information in the terminal storage unit 11, and transmit information containing the photo and the additional information.

Next, the image receiving unit 211 of the server apparatus 2 receives information containing the photo, from the terminal apparatus 1. The server apparatus 2 performs processing as in Specific Example 1, and transmits four pieces of object information, to the terminal apparatus 1 from which the photo and the like were transmitted. It is assumed that the four pieces of object information contain four object identifiers (necktie, jacket, pants, shoes), positional information ((x₁₁,y₁₁) (x₁₂,y₁₂)) corresponding to the object identifier “necktie”, positional information ((x₂₁,y₂₁) (x₂₂,y₂₂)) corresponding to the object identifier “jacket”, positional information ((x₃₁,y₃₁) (x₃₂,y₃₂)) corresponding to the object identifier “pants”, and positional information ((x₄₁,y₄₁) (x₄₂,y₄₂)) corresponding to the object identifier “shoes”.

Next, the terminal receiving unit 14 of the terminal apparatus 1 receives the four pieces of object information from the server apparatus 2. The terminal apparatus 1 performs processing as in Specific Example 1, and outputs a screen as shown in FIG. 6.

Next, it is assumed that the user wants to purchase a jacket or the like that goes with the pants in the photo, and inputs an instruction to select “pants” from among the displayed four object identifiers. Then, the terminal accepting unit 12 of the terminal apparatus 1 accepts a selecting operation on “pants” among the output four object identifiers. The terminal output unit 15 changes the display mode such that the display of the object identifier “pants” can be visually distinguished from the other object identifiers. In this example, the terminal output unit 15 changes the display of the object identifier “pants” to display in an inverted color (see 601).

Next, it is assumed that the user has pressed the “Transmit” button (602) in FIG. 6. The terminal accepting unit 12 accepts an instruction to transmit the operation information. The terminal transmitting unit 13 constructs operation information containing the selected object identifier “pants” and additional information. In this example, the additional information is a camera mode “selfie” in the camera information. Next, the terminal transmitting unit 13 transmits the operation information to the server apparatus 2. If additional information is transmitted together with a photo, the operation information preferably does not have additional information.

Next, the operation information receiving unit 212 of the server apparatus 2 receives the operation information from the terminal apparatus 1.

Next, the presentation information acquiring unit 222 acquires an object identifier “pants” contained in the received operation information. Next, the presentation information acquiring unit 222 acquires additional information “selfie” from among previously received images and the like.

Next, the presentation information acquiring unit 222 acquires presentation information using the acquired object identifier “pants” and the additional information “selfie”. That is to say, the presentation information acquiring unit 222 performs processing for acquiring product information of a product that is different from the object identifier “pants”, from the additional information “selfie”. More specifically, in this example, processing is performed for acquiring product information corresponding to the object identifiers “necktie”, “jacket”, and “shoes” excluding the object identifier “pants” and already received. For example, the presentation information acquiring unit 222 preferably acquires attribute values such as color or shape of “pants” in the photo, and acquires one or more types of product information among “necktie”, “jacket”, and “shoes” that go with “pants” in the photo, using the attribute values. In this example, it is assumed that the presentation information acquiring unit 222 acquires four pieces of product information that are paired with the object identifier “necktie”, two pieces of product information that are paired with “jacket”, and three pieces of product information that are paired with “shoes”, from the storage unit 20. The presentation information acquiring unit 222 constructs presentation information, using the acquired product information.

Next, the presentation information transmitting unit 232 transmits the constructed presentation information to the terminal apparatus 1.

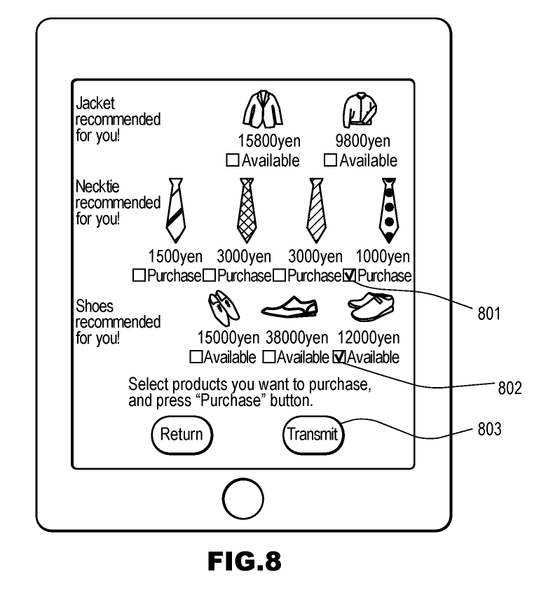

Next, the terminal receiving unit 14 of the terminal apparatus 1 receives the presentation information from the server apparatus 2. The terminal output unit 15 outputs the received presentation information. FIG. 8 shows such an output example. In FIG. 8, product information on the jacket, the necktie, and the shoes that go with “pants” selected by the user is output.

Next, on the screen in FIG. 8, the user selects a product that he or she wants to purchase (801, 802), and presses a “Purchase” button 803. Then, the terminal accepting unit 12 accepts user's selection on the output presentation information. The terminal transmitting unit 13 constructs purchase information, based on the accepted user's selection. In this example, the purchase information has an identifier for identifying the selected necktie, an identifier for identifying the selected shoes, a user identifier for identifying the user, and the like. It is assumed that the user identifier is stored, for example, in the terminal storage unit 11. Next, the terminal transmitting unit 13 transmits purchase information to the server apparatus 2.

Next, the purchase information receiving unit 213 of the server apparatus 2 receives the purchase information from the terminal apparatus 1. The payment processing unit 223 performs payment processing, using the received purchase information.

Through the above-described processing, it is possible to present product information using a photo or the like, and to purchase a product. Furthermore, presentation information corresponding to the additional information “selfie mode” is provided to the user.

In Specific Example 2, if the user selects two or more object identifiers in FIG. 6, select information containing two or more object identifiers is transmitted from the terminal apparatus 1 to the server apparatus 2. The presentation information acquiring unit 222 of the server apparatus 2 acquires presentation information using the two or more object identifiers contained in the select information. The presentation information transmitting unit 232 transmits the presentation information. If the user selects the pants and the necktie in FIG. 6, for example, the presentation information acquiring unit 222 acquires product information on one or more jackets that are products that are of a type different from the necktie and the pants in the photo, and constructs presentation information. The recommending algorithm for acquiring product information on one or more jackets may be known algorithms as described above. The acquiring presentation information using two or more object identifiers contained in the select information is the acquiring presentation information that is information on an object that goes with two or more objects corresponding to two or more object identifiers contained in the select information (an object that is of a type different from the two or more objects).

### Specific Example 3

First, it is assumed that the user of the terminal apparatus 1 sets the camera mode of the terminal apparatus 1 to a “normal” mode, which is a non-selfie mode. The “normal” typically refers to a camera located on the side opposite to the display screen of the terminal apparatus. Then, the terminal accepting unit 12 accepts an instruction to set the camera mode to a “normal” mode. The terminal processing unit (not shown) sets the camera mode to a “normal” mode.

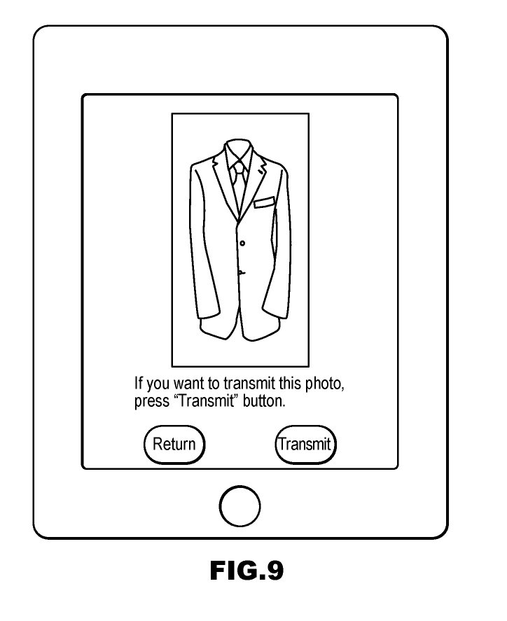

Next, it is assumed that the user of the terminal apparatus 1 captures an image of a mannequin in clothes in a shop using the camera of the terminal apparatus 1. That is to say, the terminal accepting unit 12 of the terminal apparatus 1 accepts an image capturing instruction. The image capturing unit 16 acquires a photo of the mannequin through image capturing, and temporarily stores the photo in the terminal storage unit 11. The terminal output unit 15 displays the acquired photo on the display screen. FIG. 9 shows such a photo.

Next, it is assumed that the user has input a photo transmitting instruction to transmit the photo displayed on the display screen, to the terminal apparatus 1. Next, the terminal accepting unit 12 accepts the photo transmitting instruction. The terminal transmitting unit 13 constructs information that is to be transmitted, using the photo corresponding to the photo transmitting instruction and the additional information “normal” in the terminal storage unit 11, and transmits the information.

Next, the image receiving unit 211 of the server apparatus 2 receives information containing the photo and the additional information, from the terminal apparatus 1. The server apparatus 2 performs processing as in Specific Example 1, acquires two pieces of object information (object information of the necktie and object information of the jacket), using the photo, and transmits the object information, to the terminal apparatus 1 from which the photo and the like were transmitted. It is assumed that the two pieces of object information contain two object identifiers (necktie, jacket), positional information ((x₁₁,y₁₁) (x₁₂,y₁₂)) corresponding to the object identifier “necktie”, and positional information ((x₂₁,y₂₁) (x₂₂,y₂₂)) corresponding to the object identifier “jacket”. The image receiving unit 211 temporarily stores the received additional information in the terminal storage unit 11.

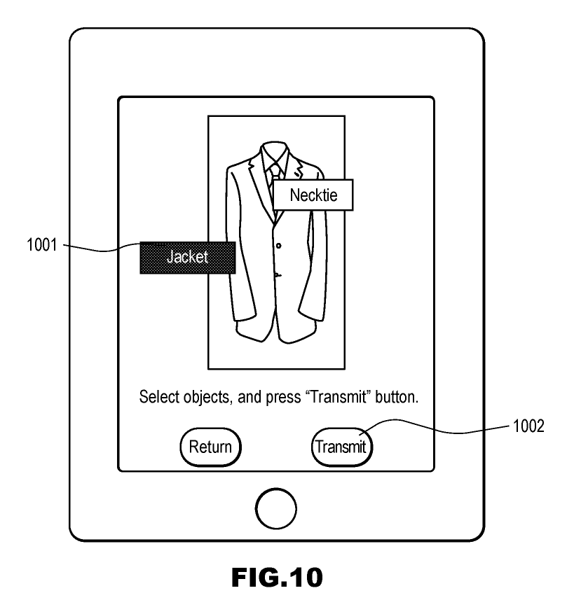

Next, the terminal receiving unit 14 of the terminal apparatus 1 receives the two pieces of object information from the server apparatus 2. The terminal apparatus 1 performs processing as in Specific Example 1, and outputs a screen as shown in FIG. 10.

Next, it is assumed that the user wants to purchase a jacket that is the same as or of the same type as the jacket in the photo, and inputs an instruction to select “jacket” from among the displayed two object identifiers. Then, the terminal accepting unit 12 of the terminal apparatus 1 accepts a selecting operation on “jacket” among the output two object identifiers. The terminal output unit 15 changes the display mode such that the display of the object identifier “jacket” can be visually distinguished from the other object identifiers. In this example, the terminal output unit 15 changes the display of the object identifier “jacket” to display in an inverted color (see 1001).

Next, it is assumed that the user has pressed a “Transmit” button (1002) in FIG. 10. The terminal accepting unit 12 accepts an instruction to transmit the operation information. The terminal transmitting unit 13 constructs operation information containing the selected object identifier “jacket”. Next, the terminal transmitting unit 13 transmits the operation information to the server apparatus 2.

Next, the operation information receiving unit 212 of the server apparatus 2 receives the operation information from the terminal apparatus 1.

Next, the presentation information acquiring unit 222 acquires an object identifier “jacket” contained in the received operation information. Next, the presentation information acquiring unit 222 acquires additional information “normal” previously received and stored in the terminal storage unit 11.

Next, the presentation information acquiring unit 222 acquires presentation information using the acquired object identifier “jacket” and the additional information “normal”. That is to say, the presentation information acquiring unit 222 performs processing for acquiring product information of a product that is the same as or of the same type as the object identifier “jacket”, from the additional information “normal”. In this example, it is assumed that the presentation information acquiring unit 222 performs processing for acquiring product information of a product that is the same as the object identifier “jacket”, from the additional information “normal”. The presentation information acquiring unit 222 preferably acquires attribute values such as color or shape of “jacket” in the photo, and acquires, as product information of the same product, product information whose similarity with “jacket” in the photo is equal to or greater than a threshold (e.g., 90 [when full match is taken as 100]), using the attribute values, from the storage unit 20. The presentation information acquiring unit 222 constructs presentation information, using the acquired product information.

Next, the presentation information transmitting unit 232 transmits the constructed presentation information to the terminal apparatus 1.

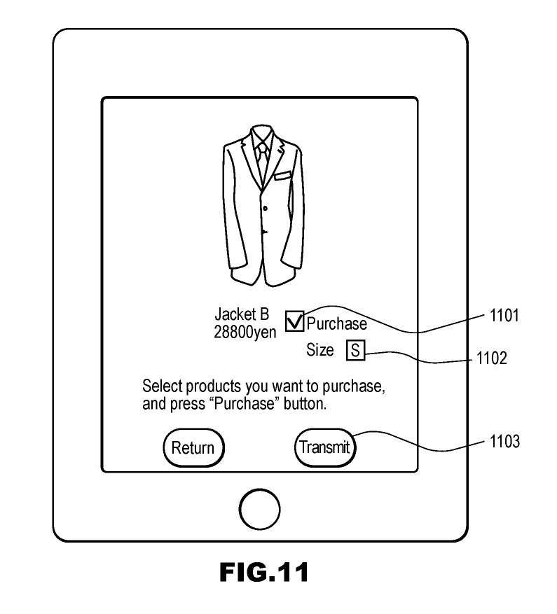

Next, the terminal receiving unit 14 of the terminal apparatus 1 receives the presentation information from the server apparatus 2. The terminal output unit 15 outputs the received presentation information. FIG. 11 shows such an output example.

Next, on the screen in FIG. 11, the user who has been determined to make a purchase selects a product (1101), inputs the size “S”, and presses a “Purchase” button 1103. Then, the terminal accepting unit 12 accepts user's selection on the output presentation information. The terminal transmitting unit 13 constructs purchase information, based on the accepted user's selection. In this example, the purchase information contains an identifier for identifying the selected jacket, a user identifier for identifying a user, and the like. It is assumed that the user identifier is stored, for example, in the terminal storage unit 11. Next, the terminal transmitting unit 13 transmits purchase information to the server apparatus 2.

Next, the purchase information receiving unit 213 of the server apparatus 2 receives the purchase information from the terminal apparatus 1. The payment processing unit 223 performs payment processing, using the received purchase information.

Through the above-described processing, it is possible to search for and present product information using an image such as a photo, and to purchase a product. Through the above-described processing, presentation information corresponding to the additional information “normal mode” is provided to the user.

### Specific Example 4

First, it is assumed that the user of the terminal apparatus 1 captures an image of a mannequin in clothes, using a camera of the terminal apparatus 1. That is to say, the terminal accepting unit 12 of the terminal apparatus 1 accepts an image capturing instruction. The image capturing unit 16 acquires a photo (an image) through image capturing, and temporarily stores the photo in the terminal storage unit 11. The terminal output unit 15 displays the acquired photo on the display screen. FIG. 9 shows such a photo.

Next, it is assumed that the user has input a photo transmitting instruction to transmit the photo displayed on the display screen, to the terminal apparatus 1 (has pressed a “Transmit” button 901). Next, the terminal accepting unit 12 accepts the photo transmitting instruction. The terminal transmitting unit 13 constructs information that is to be transmitted, using the photo corresponding to the photo transmitting instruction, and transmits the information.

Next, the image receiving unit 211 of the server apparatus 2 receives information containing the photo, from the terminal apparatus 1.

The object information acquiring unit 221 performs image recognition processing on the received photo, using an algorithm such as deep learning, recognizes two objects in the photo, and acquires object identifiers (necktie, jacket) of the two objects.

Next, the presentation information acquiring unit 222 acquires presentation information using the acquired two object identifiers (necktie, jacket). In this example, the presentation information acquiring unit 222 acquires product information (e.g., product information on pants) that goes with the necktie and the jacket corresponding to the object identifier “necktie” or “jacket”, from the storage unit 20. It is assumed that product combination information (having two or more product identifiers) such as acquiring product information on pants for a necktie and a jacket is stored in the storage unit 20. The product information on pants that go with a necktie and a jacket may be acquired using recommending algorithms as described above.

The presentation information acquiring unit 222 constructs presentation information containing the acquired product information. The presentation information has, in addition to the product information, a check box for selecting that purchase is to be made, a field for inputting a size, and the like. It is assumed that information and the like constituting user interfaces such as the check box and the field are stored in advance in the storage unit 20.

Next, the presentation information transmitting unit 232 transmits the constructed presentation information to the terminal apparatus 1.

Next, the terminal receiving unit 14 of the terminal apparatus 1 receives the presentation information from the server apparatus 2. The terminal output unit 15 outputs the received presentation information. FIG. 7 shows such an output example.

Next, on the output screen of the presentation information, the user selects a product that he or she wants to purchase, and presses a “Transmit” button. Then, the terminal accepting unit 12 accepts user's selection on the output presentation information. The terminal transmitting unit 13 constructs purchase information, based on the accepted user's selection. Next, the terminal transmitting unit 13 transmits purchase information to the server apparatus 2.

Next, the purchase information receiving unit 213 of the server apparatus 2 receives the purchase information from the terminal apparatus 1. The payment processing unit 223 performs payment processing, using the received purchase information.

Through the above-described processing, it is possible to automatically acquire presentation information merely by transmitting a photo, and to easily purchase a product. In Specific Example 4, the presentation information acquiring unit 222 may acquire, as presentation information, product information on objects that are the same as the two objects recognized in the photo. In this case, the presentation information acquiring unit 222 may acquire product information on objects that are the same as the two objects recognized in the photo, through image search or the like from an external apparatus.

As described above, according to this embodiment, it is possible to present information using a captured image or the like.

Furthermore, according to this embodiment, it is possible to present proper information using a captured image or the like, through interaction with a user.

Furthermore, according to this embodiment, it is possible to present extremely proper information according to additional information such as a camera mode, using a captured image or the like, and further using the additional information.

The processing in this embodiment may be realized by software. The software may be distributed by software downloads or the like. Furthermore, the software may be distributed in a form where the software is stored in a storage medium such as a CD-ROM. Note that the same is applied to other embodiments described in this specification. The software that realizes the terminal apparatus 1 in this embodiment is the following sort of program. Specifically, this program is a program for causing a computer-accessible storage medium to have a terminal storage unit in which an image containing one or at least two objects is stored, and causing a computer to function as: a terminal transmitting unit that transmits the image to the server apparatus; a terminal receiving unit that receives presentation information, which is information that is to be presented to a user and is information related to a product; and a terminal output unit that outputs the presentation information.

It is preferable that the program causes the computer to further function as: a terminal receiving unit that receives one or more pieces of object information from the server apparatus; a terminal output unit that outputs the image and one or more object identifiers contained in the one or more pieces of object information; and a terminal accepting unit that accepts a user's operation on one or more object identifiers output by the terminal output unit, wherein the terminal transmitting unit transmits operation information related to the operation accepted by the terminal accepting unit, to the server apparatus.

Furthermore, the software that realizes the server apparatus 2 in this embodiment is the following sort of program. Specifically, this program is a program for causing a computer to function as: an image receiving unit that receives an image from a terminal apparatus; an object information acquiring unit that recognizes one or more objects through image recognition processing on the image received by the image receiving unit, acquires object identifiers for respectively identifying the one or more objects, and acquires one or more pieces of object information respectively containing the object identifiers; a presentation information acquiring unit that, using the one or more pieces of object information acquired by the object information acquiring unit, acquires, as presentation information, object information of an object that is related to an object identified with one object identifier contained in one of the one or more pieces of object information and that is of a type different from the object; and a presentation information transmitting unit that transmits the presentation information to the terminal apparatus.

It is preferable that the program causes the computer to function such that the presentation information acquiring unit further acquires, as presentation information, object information of an object that is a same as an object identified with the one object identifier, or object information of an object that is of a same type as an object identified with the one object identifier.

It is preferable that the program causes the computer to further function as: an object information transmitting unit that transmits one or more pieces of object information acquired by the object information acquiring unit; and an operation information receiving unit that receives the operation information from the terminal apparatus, wherein the presentation information acquiring unit acquires presentation information that is to be presented to a user, using the operation information received by the operation information receiving unit.

It is preferable that the program causes the computer to function such that the operation information has one object identifier selected by a user from among the one or more object identifiers output by the terminal output unit, and the presentation information acquiring unit acquires presentation information, using object information of an object identified with the one object identifier.

It is preferable that the program causes the computer to function such that the presentation information acquiring unit acquires, as presentation information, object information of an object that is related to an object identified with the one object identifier and that is of a type different from the object, or acquires, as presentation information, object information of an object that is a same as an object identified with the one object identifier, or object information of an object that is of a same type as an object identified with the one object identifier.

It is preferable that the program causes the computer to function such that the image receiving unit receives, together with the image, additional information that is information other than the image, and the presentation information acquiring unit uses a different algorithm for acquiring presentation information, depending on the additional information.

It is preferable that the program causes the computer to function such that the additional information contains camera information related to a camera that captured the image.

It is preferable that the program causes the computer to function such that, in a case where the camera information is information indicating a selfie mode, the presentation information acquiring unit acquires, as presentation information, object information of an object that is of a type different from an object identified with the one object identifier, and, in a case where the camera information is information indicating a non-selfie mode, the presentation information acquiring unit acquires, as presentation information, object information of an object that is a same as or of a same type as an object identified with the one object identifier.

It is preferable that the program causes the computer to function such that the object information acquiring unit recognizes the two or more objects through image recognition processing using deep learning on the image received by the image receiving unit, acquires object identifiers for respectively identifying the two or more objects, and acquires two or more pieces of object information respectively containing the object identifiers.

It is preferable that the program causes the computer to further function as: a purchase information receiving unit that receives the purchase information from the terminal apparatus; and a payment processing unit that performs payment processing, using the purchase information.

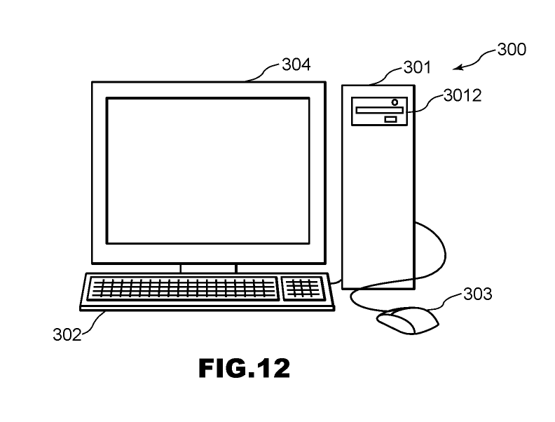

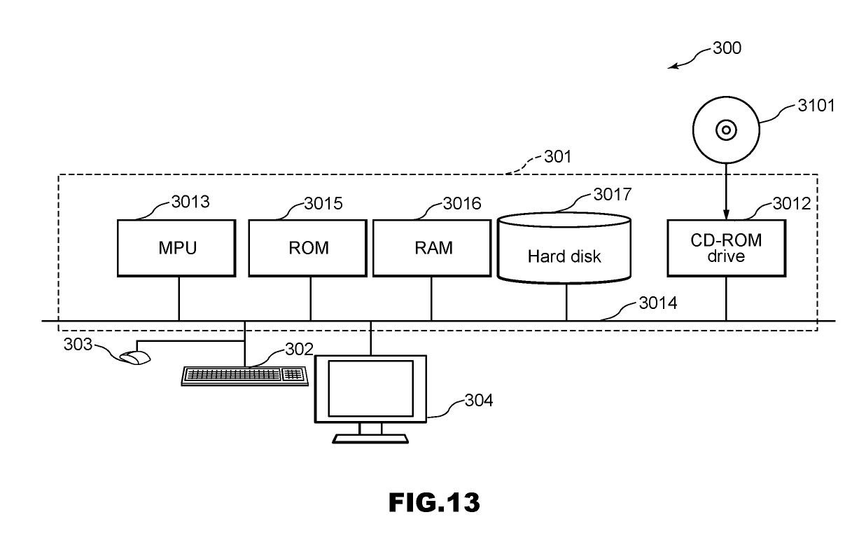

FIG. 12 shows the external appearance of a computer that executes the programs described in this specification to realize the terminal apparatus 1 or the server apparatus 2 in the foregoing various embodiments. The foregoing embodiments may be realized using computer hardware and a computer program executed thereon. FIG. 12 is a schematic view of a computer system 300. FIG. 13 is a block diagram of the system 300.

In FIG. 12, the computer system 300 includes a computer 301 including a CD-ROM drive 3012, a keyboard 302, a mouse 303, and a monitor 304. Note that the computer system 300 may include a camera.

In FIG. 13, the computer 301 includes the CD-ROM drive 3012, an MPU 3013, a bus 3014, a ROM 3015, a RAM 3016, and a hard disk 3017. In the ROM 3015, a program such as a boot up program is stored. The RAM 3016 is connected to the MPU 3013 and is a memory in which a command of an application program is temporarily stored and a temporary storage area is provided. In the hard disk 3017, typically, an application program, a system program, and data are stored. Although not shown, the computer 301 may further include a network card that provides connection to a LAN.

The programs for causing the computer system 300 to execute the functions of the server apparatus 2 and the like in the foregoing embodiments may be stored in a CD-ROM 3101 that is inserted into the CD-ROM drive 3012, and be transmitted to the hard disk 3017. Alternatively, the programs may be transmitted via a network (not shown) to the computer 301 and stored in the hard disk 3017. At the time of execution, the programs are loaded into the RAM 3016. The programs may be loaded from the CD-ROM 3101, or directly from a network.

The programs do not necessarily have to include, for example, an operating system (OS) or a third party program to cause the computer 301 to execute the functions of the server apparatus 2 and the like in the foregoing embodiments. The programs may only include a command portion to call an appropriate module in a controlled mode and obtain desired results. The manner in which the computer system 300 operates is well known, and thus a detailed description thereof has been omitted.

It should be noted that, in the programs, in a step of transmitting information, a step of receiving information, or the like, processing that is performed by hardware, for example, processing performed by a modem or an interface card in the transmitting step (processing that can be performed only by hardware) is not included.

Furthermore, the computer that executes the programs may be a single computer, or may be multiple computers. That is to say, centralized processing may be performed, or distributed processing may be performed.

Furthermore, in the foregoing embodiments, it will be appreciated that two or more communication parts in one apparatus may be physically realized by one medium.

In the foregoing embodiments, each process (each function) may be realized as centralized processing using a single apparatus (system), or may be realized as distributed processing using multiple apparatuses.

The present invention is not limited to the embodiment set forth herein. Various modifications are possible within the scope of the present invention.

### INDUSTRIAL APPLICABILITY

As described above, the information system according to the present invention has an effect that it is possible to recommend information using a captured image or the like, and thus this system is useful as an information system and the like.

### LIST OF REFERENCE NUMERALS

1 Terminal apparatus
2 Server apparatus
11 Terminal storage unit
12 Terminal accepting unit
13 Terminal transmitting unit
14 Terminal receiving unit
15 Terminal output unit
16 Image capturing unit
20 Storage unit
21 Receiving unit
22 Processing unit
23 Transmitting unit
211 Image receiving unit
212 Operation information receiving unit
213 Purchase information receiving unit
221 Object information acquiring unit
222 Presentation information acquiring unit
223 Payment processing unit
231 Object information transmitting unit
232 Presentation information transmitting unit

1. A server apparatus constituting an information system that includes the server apparatus and a terminal apparatus,
wherein the terminal apparatus includes:
a terminal storage unit in which an image containing two or more objects is stored;
a terminal transmitting unit that transmits the image to the server apparatus;
a terminal receiving unit that receives two or more pieces of object information from the server apparatus;
a terminal output unit that outputs the image and two or more object identifiers contained in the two or more pieces of object information; and
a terminal accepting unit that accepts a user's operation on one or more of the two or more object identifiers output by the terminal output unit,
the terminal transmitting unit transmits operation information containing at least one object identifier selected by a user from among the two or more object identifiers output by the terminal output unit, to the server apparatus,
the terminal receiving unit receives presentation information, which is information that is to be presented to a user and is information related to a product, in response to transmission of the operation information,
the terminal output unit outputs the presentation information, and
the server apparatus includes:
an image receiving unit that receives the image from the terminal apparatus;
an object information acquiring unit that recognizes the two or more objects through image recognition processing on the image received by the image receiving unit, acquires object identifiers for respectively identifying the two or more objects, and acquires two or more pieces of object information respectively containing the object identifiers;
an object information transmitting unit that transmits the two or more pieces of object information acquired by the object information acquiring unit;
an operation information receiving unit that receives the operation information from the terminal apparatus after the two or more pieces of object information are transmitted;
a presentation information acquiring unit that acquires presentation information that is to be presented to a user, using the operation information received by the operation information receiving unit; and
a presentation information transmitting unit that transmits the presentation information to the terminal apparatus.

2. The server apparatus according to claim 1,
wherein a selecting operation can be accepted on object identifiers contained in the object information transmitted by the object information transmitting unit,
the terminal output unit outputs the image and two or more object identifiers, and
the terminal accepting unit accepts a user's selection operation on one or more of the two or more object identifiers output by the terminal output unit.

3. The server apparatus according to claim 2,
wherein the object information acquiring unit further acquires positional information indicating relative positions of the two or more objects in the image, and acquires two or more pieces of object information containing object identifiers for respectively identifying the two or more objects and the positional information, and
the terminal output unit determines positions to which the object identifiers are to be output, using the positional information corresponding to the object identifiers, and outputs the two or more object identifiers to the determined positions.

4. The server apparatus according to claim 1,
wherein the image receiving unit receives, together with the image, additional information that is information other than the image, and
the presentation information acquiring unit acquires, as presentation information, object information of an object that is of a type different from an object identified with the one object identifier, or acquires, as presentation information, object information of an object that is a same as or of a same type as an object identified with the one object identifier, depending on the additional information.

5. The server apparatus according to claim 1,
wherein the image receiving unit receives, together with the image, additional information that is information other than the image,
the presentation information acquiring unit acquires presentation information using a different algorithm depending on the additional information, and
the additional information contains camera information related to a camera that captured the image.

6. The server apparatus according to claim 5, wherein, in a case where the camera information is information indicating a selfie mode, the presentation information acquiring unit acquires, as presentation information, object information of an object that is of a type different from an object identified with the one object identifier, and, in a case where the camera information is information indicating a non-selfie mode, the presentation information acquiring unit acquires, as presentation information, object information of an object that is a same as or of a same type as an object identified with the one object identifier.

7. The server apparatus according to claim 1, wherein the object information acquiring unit recognizes the two or more objects through image recognition processing using deep learning on the image received by the image receiving unit, acquires object identifiers for respectively identifying the two or more objects, and acquires two or more pieces of object information respectively containing the object identifiers.

8. The server apparatus according to claim 1,
wherein the terminal accepting unit accepts user's selection on presentation information output by the terminal output unit,
the terminal transmitting unit transmits purchase information related to the user's selection accepted by the terminal accepting unit, to the server apparatus,
the server apparatus further includes:
a purchase information receiving unit that receives the purchase information from the terminal apparatus; and
a payment processing unit that performs payment processing, using the purchase information.

9. A server apparatus comprising:
an image receiving unit that receives an image containing two or more objects from a terminal apparatus;
an object information acquiring unit that recognizes the two or more objects through image recognition processing on the image received by the image receiving unit, acquires object identifiers for respectively identifying the two or more objects, and acquires two or more pieces of object information respectively containing the object identifiers;
an object information transmitting unit that transmits the two or more pieces of object information acquired by the object information acquiring unit;
an operation information receiving unit that receives operation information related to user's operation on one or more object identifiers from among the two or more object identifiers output by the terminal apparatus, from the terminal apparatus, after the two or more pieces of object information are transmitted;
a presentation information acquiring unit that acquires presentation information that is to be presented to a user, using the operation information received by the operation information receiving unit; and
a presentation information transmitting unit that transmits the presentation information to the terminal apparatus.

10. A terminal apparatus comprising:
a terminal storage unit in which an image containing two or more objects is stored;
a terminal transmitting unit that transmits the image to a server apparatus;
a terminal receiving unit that receives two or more pieces of object information from the server apparatus;
a terminal output unit that outputs the image and two or more object identifiers contained in the two or more pieces of object information; and
a terminal accepting unit that accepts a user's operation on one or more of the two or more object identifiers output by the terminal output unit,
wherein the terminal transmitting unit transmits operation information containing at least one object identifier selected by a user from among the two or more object identifiers output by the terminal output unit, to the server apparatus,
the terminal receiving unit receives presentation information, which is information that is to be presented to a user and is information related to a product, in response to transmission of the operation information, and
the terminal output unit outputs the presentation information.

11. An information processing method realized by an image receiving unit, an object information acquiring unit, an object information transmitting unit, an operation information receiving unit, a presentation information acquiring unit, and a presentation information transmitting unit, the method comprising:
an image receiving step of the image receiving unit receiving an image containing two or more objects from a terminal apparatus;
an object information acquiring step of the object information acquiring unit recognizing the two or more objects through image recognition processing on the image received in the image receiving step, acquiring object identifiers for respectively identifying the two or more objects, and acquiring two or more pieces of object information respectively containing the object identifiers;
an object information transmitting step of the object information transmitting unit transmitting the two or more pieces of object information acquired in the object information acquiring step;
an operation information receiving step of the operation information receiving unit receiving the operation information from the terminal apparatus, after the two or more pieces of object information are transmitted;
a presentation information acquiring step of the presentation information acquiring unit acquiring presentation information that is to be presented to a user, using the operation information received in the operation information receiving step; and
a recommendation information transmitting step of the presentation information transmitting unit transmitting the presentation information to the terminal apparatus.

12. An information processing method realized by a terminal transmitting unit, a terminal receiving unit, a terminal output unit, and a terminal accepting unit, the method comprising:
a terminal transmitting step of the terminal transmitting unit transmitting an image containing two or more objects to a server apparatus;
a terminal receiving step of the terminal receiving unit receiving two or more pieces of object information from the server apparatus;
a terminal output step of the terminal output unit outputting the image and two or more object identifiers contained in the two or more pieces of object information;
a terminal accepting step of the terminal accepting unit accepting a user's operation on one or more of the two or more object identifiers output in the terminal output step;
a step of the terminal transmitting unit transmitting operation information containing at least one object identifier selected by a user from among the two or more object identifiers output in the terminal output step, to the server apparatus;
a step of the terminal receiving unit receiving presentation information, which is information that is to be presented to a user and is information related to a product, in response to transmission of the operation information; and
a step of the terminal output unit outputting the presentation information.
